(19) United States
(12) Patent Application Publication
(10) Pub. No.: US 2024/0144135 A1
(43) Pub. Date: May 2, 2024

(54) SYSTEMS AND METHODS FOR RISK PROCESSING OF SUPPLY CHAIN MANAGEMENT SYSTEM DATA

(71) Applicant: JABIL INC., St. Petersburg, FL (US)

(72) Inventors: JENNIFER FOSTER, St. Petersburg, FL (US); JEFF MILLER, St. Petersburg, FL (US); ERIN DUNLOP, St. Petersburg, FL (US); ANDY JOYNER, St. Petersburg, FL (US)

(21) Appl. No.: 18/569,285

(22) PCT Filed: Jun. 16, 2022
(86) PCT No.: PCT/US22/33852

§ 371 Date: Dec. 12, 2023

Related U.S. Application Data
(60) Provisional application No. 63/212,495, filed on Jun. 18, 2021.

(51) Int. Cl. G06Q 10/0635; G06Q 10/08

(52) U.S. Cl. CPC G06Q 10/0635; G06Q 10/08

(57) ABSTRACT

Apparatus, system and method for a predictive risk manager for managing a supply chain comprising a plurality of supply chain nodes. Included in a risk manager are: a managing central hub comprising a plurality of primary data regarding anonymized hardware and software product data from the plurality of supply chain nodes, and life cycle data for all parts employed at the plurality of supply chain nodes; an input to the managing central hub comprising current proprietary data regarding a product made at one of the plurality of supply chain nodes; a plurality of rules capable of recognizing a predictive non-competitive part related risk embedded in the proprietary data, the plurality of rules calculating a recommended redesign to address the predictive non-competitive part related risk before it arises; and an output from the managing central hub to a graphical user interface, wherein the non-competitive part related risk and the recommended redesign are presented on the graphical user interface.

### CROSS-REFERENCE TO RELATED APPLICATION

This application claims the benefit of priority to U.S. Provisional Application No. 63/212,495, filed Jun. 18, 2021, entitled SYSTEMS AND METHODS FOR RISK PROCESSING OF SUPPLY CHAIN MANAGEMENT SYSTEM DATA, the entirety of which is incorporated herein by reference as if set forth in its entirety.

### BACKGROUND

### Field of the Disclosure

The present disclosure relates to supply chain management (SCM) system processing. More specifically, the present disclosure is related to processing SCM data to reduce cost, optimize data processing and networked communications, improving flexibility, and identifying and mitigating risk in a supply chain. Furthermore, the SCM data may be structured using visualization, analytics and frameworks.

### Background of the Disclosure

Supply chains have become increasingly complex, and product companies are faced with numerous challenges such as globalization, shortening product lifecycles, high mix product offerings and countless supply chain procurement models. In addition, challenging economic conditions have placed additional pressure on companies to reduce cost to maximize margin or profit. Focus areas of supply chain-centric companies include reducing cost in the supply chain, maximizing flexibility across the supply chain, and mitigating risks in the supply chain to prevent lost revenue.

Supply chain risk, or the likelihood of supply chain disruptions, is emerging as a key challenge to SCM. The ability to identify which supplier has a greater potential of a disruption is an important first step in managing the frequency and impact of these disruptions that often significantly impact a supply chain. Currently, supply chain risk management approaches seek to measure either supplier attributes or the supply chain structure, where the findings are used to compare suppliers and predict disruption. The results are then used to prepare proper mitigation and response strategies associated with these suppliers. Ideally, such risk management and assessment would be performed during the design of a supply chain for a product or line of products, but design tools and data analysis to allow for such design capabilities are not available in the known art.

Rather than the data- and algorithm-centric supply chain design and risk analysis discussed above, supply chain risk management is instead most often a formal, largely manual process that involves identifying potential losses, understanding the likelihood of potential losses, assigning significance to these losses, and taking steps to proactively prevent these losses. A conventional example of such an approach is the purchasing risk and mitigation (PRAM) methodology developed by the Dow Chemical Company to measure supply chain risks and its impacts. This approach examines supply market risk, supplier risk, organization risk and supply strategy risk as factors for supply chain analysis. Generally speaking, this approach is based on the belief that supplier problems account for the large majority of shutdowns and supply chain failures.

Such conventional systems are needlessly complicated and somewhat disorganized in that multiple layers of classification risks are utilized and, too often, the systems focus mainly on proactively endeavoring to predict disruptive events instead of analyzing and processing underlying root causes and large-scale accumulated data to assess potential disruptions. Further, these conventional systems fail to provide tools to aid in the design of a supply chain at the outset to address potential breakdown and disruption, and they also give little insight or visibility into the actual supply chain over its entirety. Thus, what is needed is an efficient, simplified SCM processing system for aiding in the design of the supply chain, and thereby maximizing opportunities to address potential supply chain risks at the outset and during the life cycle of a supply chain.

Moreover, conventional supply chain management has historically been based on various assumptions that may prove incorrect. By way of example, it has generally been understood that the highest risk in the supply chain resides with suppliers with whom the highest spend occurs—however, the most significant risk in a supply chain may actually reside with small suppliers, particularly if language barriers reside between the supplier and the supply chain manager, or with sole source suppliers, or in relation to suppliers highly likely to be subject to catastrophic events, such as earthquakes, for example. Further, it has typically been the case that increased inventory results in improved delivery performance—however, this, too, may prove to be an incorrect assumption upon analysis of large-scale data over time and across multiple suppliers, at least in that this assumption is true only if an inventory buffer is placed on the correct part or parts, and at the correct service level, and this assumption fails to consider the costly nature of increased inventory. Needless to say, such information would be difficult to glean absent automated review of large-scale data over time, and without visibility across an entire supply chain.

Yet further, present supply chain management fails to account for much of the available large-scale data information. By way of example, social media or other third party data sources may be highly indicative of supply chain needs or prospective disruptions. For example, if a provider expresses a desire for increased inventory levels, but social media expresses a largely negative customer sentiment, sales are likely to fall and the increased inventory levels will likely not be necessary. Similarly, large scale data inclusive of third party data may indicate that a supplier previously deemed high risk, such as due to the threat of earthquake, is actually lower risk because that supplier has not been hit with an earthquake over magnitude 5 for the last 20 years, and earthquakes of less than magnitude 5 have only a minimal probability of affecting the supply chain in a certain vertical. As such, large scale data, such as may include social media or other third party data, may complement supply chain management in ways not provided by conventional supply chain management.

Such large scale data may further include data much closer to the particular supply chain. More specifically, it is often the case that multiple supply chains for many different products owned by many different companies are all managed by a “central hub”, such as a contract manufacturer, that has voluminous information unavailable to independent product owners, but available in the aggregate to the central hub. Such information might include trends based on similar products or parts that are not known to current product owners, but which may be known to the hub and which may provide substantial improvements in projections to avoid, for example, obsolescence of parts.

### SUMMARY OF THE DISCLOSURE

Disclosed is an apparatus, system and method for supply chain management (SCM) system processing. A SCM operating platform is operatively coupled to SCM modules for collecting, storing, distributing and processing SCM data to determine statistical opportunities and risk in a SCM hierarchy. SCM risk processing may be utilized to determine risk values that are dependent upon SCM attributes. Multiple SCM risk processing results may be produced for further drill-down by a user. SCM network nodes, their relation and status may further be produced for fast and efficient status determination.

More particularly, disclosed is a supply chain predictive risk manager for managing a supply chain comprising a plurality of supply chain nodes. Included in a risk manager are: a managing central hub comprising a plurality of primary data regarding anonymized hardware and software product data from the plurality of supply chain nodes, and life cycle data for all parts employed at the plurality of supply chain nodes; an input to the managing central hub comprising current proprietary data regarding a product made at one of the plurality of supply chain nodes; a plurality of rules stored in at least one memory element associated with the managing central hub and capable, based on the primary data, of recognizing a predictive non-competitive part related risk embedded in the proprietary data, the plurality of rules calculating, based on accumulated part related risk data from at least providers of parts and from the primary data, a recommended redesign to address the predictive non-competitive part related risk before it arises; and an output from the managing central hub to a graphical user interface, wherein the non-competitive part related risk and the recommended redesign are presented by a processor on the graphical user interface.

### BRIEF DESCRIPTION OF THE DRAWINGS

The present invention is illustrated by way of example and not limitation in the figures of the accompanying drawings, in which like references indicate similar elements and in which:

FIG. 1 illustrates a computer system for transmitting and processing data, and particularly supply chain management (SCM) data under an exemplary embodiment;

FIG. 2 illustrates an exemplary processing device suitable for use in the embodiment of FIG. 1 for processing and presenting SCM data;

FIG. 3A illustrates an exemplary SCM platform comprising a plurality of plug-in applications/modules, including a control tower module, a network optimization module, a supply chain analytics module, a supplier radar module, and a supply/demand processing module under one embodiment;

FIG. 3B illustrates the SCM platform utilizing extended plug-in applications/modules under another exemplary embodiment;

FIG. 4 illustrates aspects of the embodiments;

FIG. 5 illustrate aspects of the embodiments;

FIG. 6 illustrates aspects of the embodiments;

FIG. 7 illustrates aspects of the embodiments;

FIG. 8 illustrates aspects of the embodiments;

FIG. 9 illustrates aspects of the embodiments;

FIG. 10 illustrates aspects of the embodiments;

FIG. 11 illustrates aspects of the embodiments;

FIG. 12 illustrates aspects of the embodiments;

FIG. 13 illustrates aspects of the embodiments;

FIG. 14 illustrates aspects of the embodiments;

FIG. 15 illustrates aspects of the embodiments;

FIG. 16 illustrates aspects of the embodiments;

FIG. 17 illustrates aspects of the embodiments; and

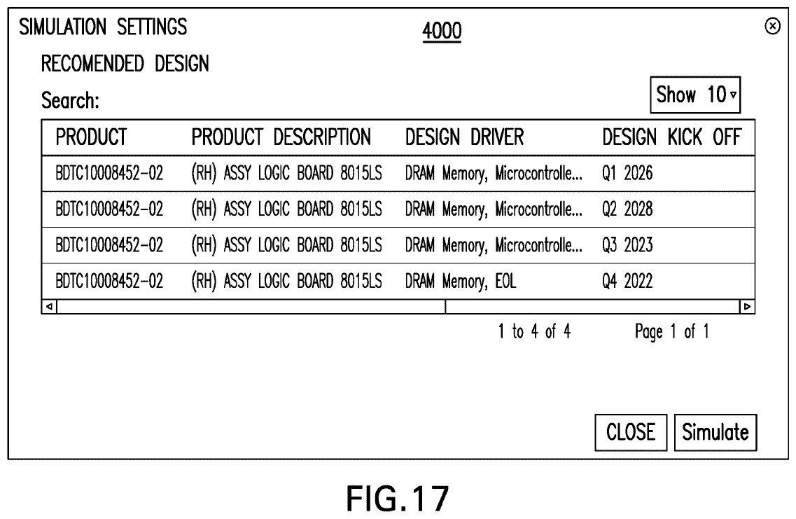

FIG. 18 illustrates aspects of the embodiments.

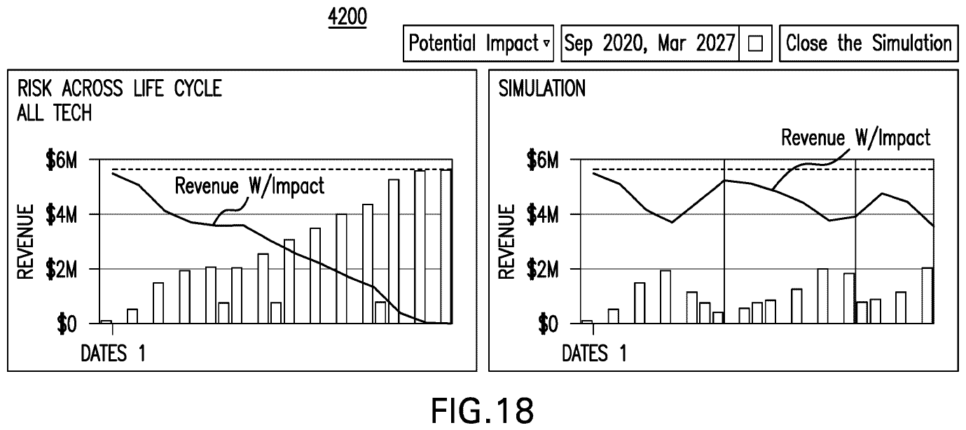

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

Computer-implemented platforms, engines, systems and methods of use are disclosed herein that provide networked access to a plurality of types of digital content, including but not limited to video, image, text, audio, metadata, algorithms, interactive and document content, and that track, deliver, manipulate, transform and report the accessed content. Described embodiments of these platforms, engines, systems and methods are intended to be exemplary and not limiting. As such, it is contemplated that the herein described systems and methods may be adapted to provide many types of server and cloud-based valuations, interactions, data exchanges, and the like, and may be extended to provide enhancements and/or additions to the exemplary platforms, engines, systems and methods described. The disclosure is thus intended to include all such extensions.

Furthermore, it will be understood that the terms “module” or “engine”, as used herein does not limit the functionality to particular physical modules, but may include any number of tangibly-embodied software and/or hardware components having a transformative effect on at least a portion of a system. In general, a computer program product in accordance with one embodiment comprises a tangible computer usable medium (e.g., standard RAM, an optical disc, a USB drive, or the like) having computer-readable program code embodied therein, wherein the computer-readable program code is adapted to be executed by a processor (working in connection with an operating system) to implement one or more functions and methods as described below. In this regard, the program code may be implemented in any desired language, and may be implemented as machine code, assembly code, byte code, interpretable source code or the like (e.g., via C, C++, C #, Java, Actionscript, Objective-C, Javascript, CSS, XML, etc.).

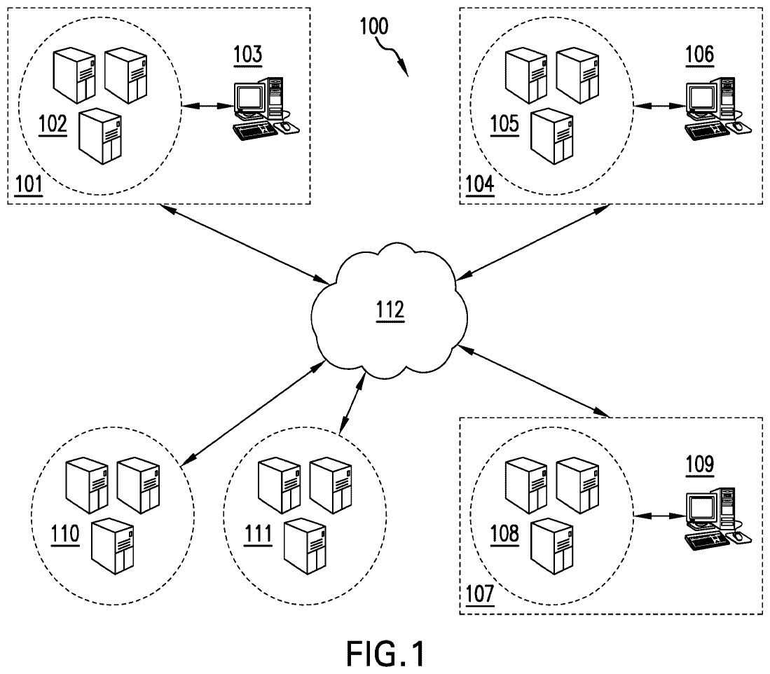

Turning to FIG. 1, an exemplary computer system is disclosed in an embodiment. In this example, computer system 100 is configured as a SCM processing system, wherein primary processing node/central hub 101 is configured to contain an SCM platform for processing data from other nodes (104, 107), which will be described in further detail below. In one embodiment, primary node/hub 101 comprises one or more servers 102 operatively coupled to one or more terminals 103. Primary node 101 is communicatively coupled to network 112, which in turn is operatively coupled to supply chain nodes 104, 107. Nodes 104, 107 may be configured as standalone nodes or, preferably, as network nodes, where each node 104, 107 comprises network servers 105, 108 and terminals 106, 109, respectively.

As will be explained in the embodiments discussed below, nodes 104, 107 may be configured as assembly nodes, part nodes, supplier nodes, manufacturer nodes and/or any other suitable supply chain node. Each of these nodes may be configured to collect, store, and process relevant supply chain-related data and transmit the SCM data to primary node 101 via network 112. Primary node 101 may further be communicatively coupled to one or more data services 110, 111 which may be associated with governmental, monetary, economic, meteorological, etc., data services. Services 110, 111 may be third-party services configured to provide general environmental data relating to SCM, such as interest rate data, tax/tariff data, weather data, trade data, currency exchange data, and the like, to further assist in SCM processing. Primary node/hub 101 may be “spread” across multiple nodes, rather than comprising a single node, may access data at any one or more of a plurality of layers from nodes 104, 107, and may be capable of applying a selectable one or more algorithms, applications, calculations, or reporting in relation to any one or more data layers from nodes 104, 107.

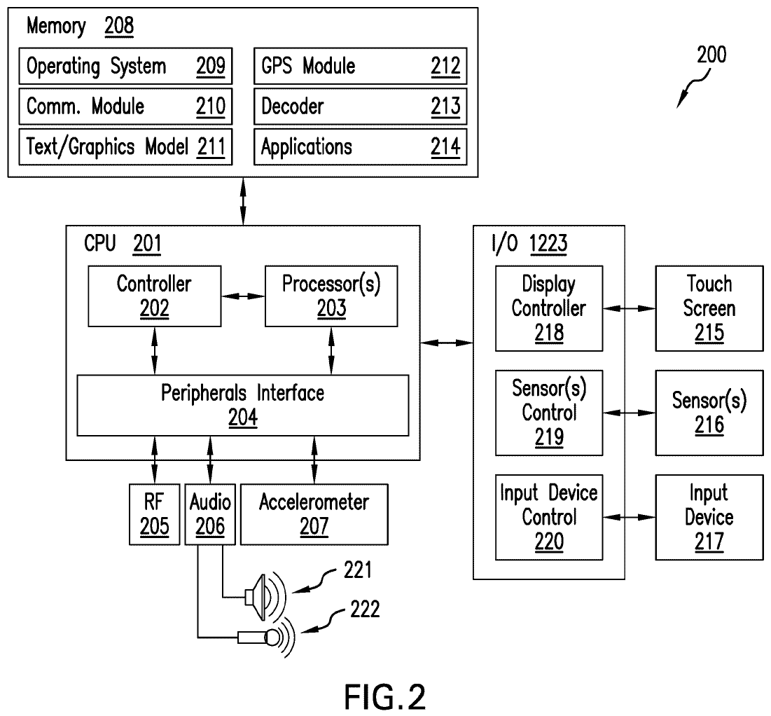

FIG. 2 is an exemplary embodiment of a computing device 200 which may function as a computer terminal (e.g., 103), and may be a desktop computer, laptop, tablet computer, smart phone, or the like. Actual devices may include greater or fewer components and/or modules than those explicitly depicted in FIG. 2. Device 200 may include a central processing unit (CPU) 201 (which may include one or more computer readable storage mediums), a memory controller 202, one or more processors 203, a peripherals interface 1204, RF circuitry 205, audio circuitry 206, a speaker 221, a microphone 222, and an input/output (I/O) subsystem 223 having display controller 218, control circuitry for one or more sensors 216 and input device control 214. These components may communicate over one or more communication buses or signal lines in device 200. It should be appreciated that device 200 is only one example of a multifunction device 200, and that device 200 may have more or fewer components than shown, may combine two or more components, or a may have a different configuration or arrangement of the components. The various components shown in FIG. 2 may be implemented in hardware or a combination of hardware and tangibly-embodied, non-transitory software, including one or more signal processing and/or application specific integrated circuits.

Data communication with device 200 may occur via a direct wired link or data communication through wireless, such as RF, interface 205, or through any other data interface allowing for the receipt of data in digital form. Decoder 213 is capable of providing data decoding or transcoding capabilities for received media, and may also be enabled to provide encoding capabilities as well, depending on the needs of the designer. Memory 208 may also include high-speed random access memory (RAM) and may also include non-volatile memory, such as one or more magnetic disk storage devices, flash memory devices, or other non-volatile solid-state memory devices. Access to memory 208 by other components of the device 200, such as processor 203, decoder 213 and peripherals interface 204, may be controlled by the memory controller 202. Peripherals interface 204 couples the input and output peripherals of the device to the processor 203 and memory 208. The one or more processors 203 run or execute various software programs and/or sets of instructions stored in memory 208 to perform various functions for the device 200 and to process data including SCM data. In some embodiments, the peripherals interface 204, processor(s) 203, decoder 213 and memory controller 202 may be implemented on a single chip, such as a chip 201. In some other embodiments, they may be implemented on separate chips.

The RF (radio frequency) circuitry 205 receives and sends RF signals, also known as electromagnetic signals. The RF circuitry 205 converts electrical signals to/from electromagnetic signals and communicates with communications networks and other communications devices via the electromagnetic signals. The RF circuitry 205 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 205 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), BLE, Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Audio circuitry 206, speaker 221, and microphone 222 may provide an audio interface between a user and the device 200. Audio circuitry 1206 may receive audio data from the peripherals interface 204, converts the audio data to an electrical signal, and transmits the electrical signal to speaker 221. The speaker 221 converts the electrical signal to human-audible sound waves. Audio circuitry 206 also receives electrical signals converted by the microphone 221 from sound waves, which may include audio. The audio circuitry 206 converts the electrical signal to audio data and transmits the audio data to the peripherals interface 204 for processing. Audio data may be retrieved from and/or transmitted to memory 208 and/or the RF circuitry 205 by peripherals interface 204. In some embodiments, audio circuitry 206 also includes a headset jack for providing an interface between the audio circuitry 206 and removable audio input/output peripherals, such as output-only headphones or a headset with both output (e.g., a headphone for one or both ears) and input (e.g., a microphone).

I/O subsystem 223 couples input/output peripherals on the device 200, such as touch screen 215 and other input/control devices 217, to the peripherals interface 204. The I/O subsystem 223 may include a display controller 218 and one or more input controllers 220 for other input or control devices. The one or more input controllers 220 receive/send electrical signals from/to other input or control devices 217. The other input/control devices 217 may include physical buttons (e.g., push buttons, rocker buttons, etc.), dials, slider switches, joysticks, click wheels, and so forth. In some alternate embodiments, input controller(s) 220 may be coupled to any (or none) of the following: a keyboard, infrared port, USB port, and a pointer device such as a mouse, an up/down button for volume control of the speaker 221 and/or the microphone 222. Touch screen 215 may also be used to implement virtual or soft buttons and one or more soft keyboards.

Touch screen 215 provides an input interface and an output interface between the device and a user. The display controller 218 receives and/or sends electrical signals from/to the touch screen 215. Touch screen 215 displays visual output to the user. The visual output may include graphics, text, icons, video, and any combination thereof (collectively termed “graphics”). In some embodiments, some or all of the visual output may correspond to user-interface objects. Touch screen 215 has a touch-sensitive surface, sensor or set of sensors that accepts input from the user based on haptic and/or tactile contact. Touch screen 215 and display controller 218 (along with any associated modules and/or sets of instructions in memory 208) detect contact (and any movement or breaking of the contact) on the touch screen 215 and converts the detected contact into interaction with user-interface objects (e.g., one or more soft keys, icons, web pages or images) that are displayed on the touch screen. In an exemplary embodiment, a point of contact between a touch screen 215 and the user corresponds to a finger of the user. Touch screen 215 may use LCD (liquid crystal display) technology, or LPD (light emitting polymer display) technology, although other display technologies may be used in other embodiments. Touch screen 215 and display controller 218 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 215.

Device 200 may also include one or more sensors 216 such as optical sensors that comprise charge-coupled device (CCD) or complementary metal-oxide semiconductor (CMOS) phototransistors. The optical sensor may capture still images or video, where the sensor is operated in conjunction with touch screen display 215. Device 200 may also include one or more accelerometers 207, which may be operatively coupled to peripherals interface 1204. Alternately, the accelerometer 207 may be coupled to an input controller 214 in the I/O subsystem 211. The accelerometer is preferably configured to output accelerometer data in the x, y, and z axes.

In one embodiment, the software components stored in memory 208 may include an operating system 209, a communication module 210, a text/graphics module 211, a Global Positioning System (GPS) module 212, audio decoder 1213 and applications 214. Operating system 209 (e.g., Darwin, RTXC, LINUX, UNIX, OS X, Windows, or an embedded operating system such as VxWorks) includes various software components and/or drivers for controlling and managing general system tasks (e.g., memory management, storage device control, power management, etc.) and facilitates communication between various hardware and software components. A SCM processing platform may be integrated as part of operating system 209, or all or some of the disclosed portions of SCM processing may occur within the one or more applications 214. Communication module 210 facilitates communication with other devices over one or more external ports and also includes various software components for handling data received by the RF circuitry 205. An external port (e.g., Universal Serial Bus (USB), Firewire, etc.) may be provided and adapted for coupling directly to other devices or indirectly over a network (e.g., the Internet, wireless LAN, etc.).

Text/graphics module 211 includes various known software components for rendering and displaying graphics on a screen and/or touch screen 215, including components for changing the intensity of graphics that are displayed. As used herein, the term “graphics” includes any object that can be displayed to a user, including without limitation text, web pages, icons (such as user-interface objects including soft keys), digital images, videos, animations and the like. Additionally, soft keyboards may be provided for entering text in various applications requiring text input. GPS module 212 determines the location of the device and provides this information for use in various applications. Applications 214 may include various modules, including address books/contact list, email, instant messaging, video conferencing, media player, widgets, instant messaging, camera/image management, and the like. Examples of other applications include word processing applications, JAVA-enabled applications, encryption, digital rights management, voice recognition, and voice replication. Under one embodiment, a 3D object may have access to any or all of features in memory 208.

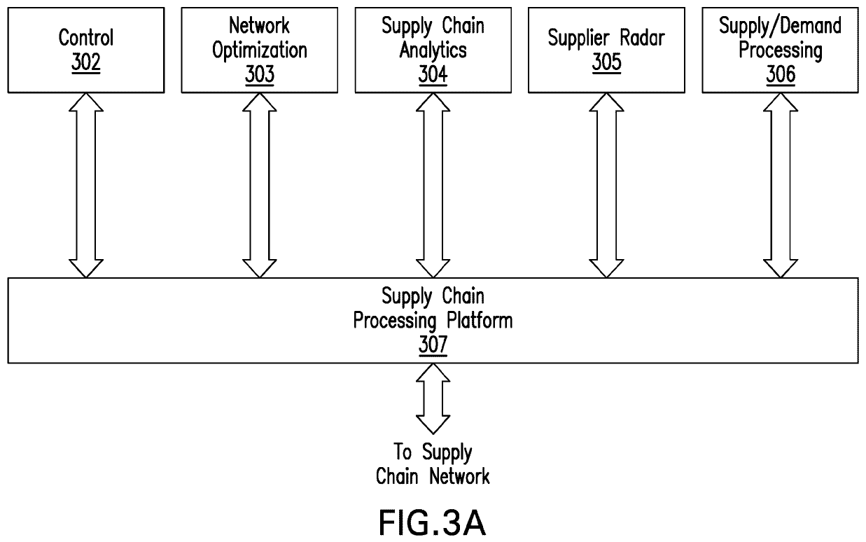

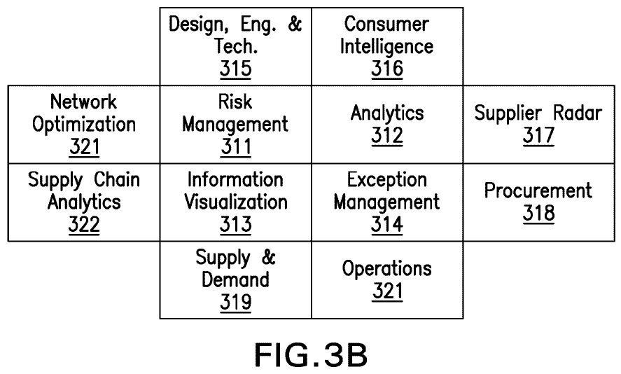

Turning to FIG. 3A, a SCM operating platform 307 is disclosed, wherein platform 307 may reside at a primary node 101. Platform 307 may be configured to perform and/or control SCM data processing on data received from external nodes 104, 107 and other data sources 110, 111. Platform 307 is operatively coupled to control module 302, which may be configured to process, connect and visualize nodes and their respective geographic locations. Network optimization module 303 processes SCM data to determine which nodes and links meet or exceed predetermined optimization thresholds and determines new nodes and/or links that may be added, deleted and/or substituted to establish more efficient network optimization.

Supply chain analytics module 304 may be configured to process incoming supply chain data and forward results to platform 307 for storage, distribution to other modules and/or for further processing. Each of modules 302-306 may share data between themselves via platform 307. Platform 307 may further be configured to generate visualizations, such as media, charts, graphs, node trees, and the like, for inspection and/or follow-up action by a user.

FIG. 3B illustrates, at the primary node 101 of a data exchange diagram, platform 307. In the illustration, platform 307 may provide a plurality of rules and processes, such as the aforementioned analytics, exception management, risk management, and visualization techniques, which may be applied by one or more modules. That is, access to the rules and processes provided by the platform may be available to the aforementioned modules. Thus, these applications, also referred to herein as “apps” or modules, may be “thin client”, wherein the processes reside entirely within the platform's processing and are accessed by the app; “thick client,” wherein the processes reside entirely within the app's processing; or partially thin client, wherein processing and rule application is shared between the app and the platform.

Data inputs for the one of more modules, also referred to in the pertinent art as “data hooks” for “apps,” may be associated with the platform 307, and thus may obtain data that is made available by the platform, such as may be obtained from hardware or software outputs provided from nodes 104, 107 and/or sources 110, 111. As illustrated, data may be received in platform modules for risk management 311, analytics 312, information visualization 313 and exception management 314. The data may be provided in the form of network optimization data 321, supply chain analytics data 322, design/engineering/technology data 315, consumer intelligence data 316, supplier data 317, procurement data 318, operations data 321, and supply and demand data 319, by way of non-limiting example.

Because the apps disclosed make use of the data, rules, algorithms, and processes provided by the platform, any number of different component apps may be provided. Apps may interface with the platform solely to obtain data, and may thereafter apply unique app-based rules, algorithms and processes to the received data; or apps may make use of the data and some or all of the rules, learning algorithms, and processes of the platform and may solely or most significantly provide variations in the visualizations regarding the secondary data produced.

Risk attribute processing results may further be used by the platform to show trends over time, as well as a current risk attribute score distribution. Such trends may be reported upon certain triggers, and/or may be tracked in order to allow automated or manual modifications to algorithms and processes of an app or the platform 307. There may be a plurality of aspects for improving the supply chain risk for a customer or assembly (thus lowering the average risk and lowering a variation of risk). For example, the data for the risk attribute module may be collected from the network via customers and suppliers, from hub/primary node 101, and may further be obtained from manufacturer nodes (e.g., 104, 107). All data is collected to determine risk attribute scores and trend them to further determine action needed to reduce risk for customers, as well as for hub/primary node operator.

Categories in which risk may occur in a supply chain design, such as five (5) risk categories, may be hierarchically treated and provided within the comparative algorithms. That is, within each category, one or more attributes may be provided that contribute to a scoring within the category. Of note, each category may be scored, as may be each attribute within each category to contribute to the category score, and these scores may be weighted, such as in relation to the stated goals and objectives of a user, as referenced further below. This weighted scoring system may then provide a total risk score for the factor, part, supplier, or the like for which the risk model was applied.

Further, the system may recommend certain aspects to the user to be employed in a risk model, such as weightings, categories, attributes, or the like. Such recommendations may be based on, for example, risk profiles of competitors, presence in a particular industry vertical, or the like.

The risk modeling and or recommendations discussed herein may comprise one or more learning algorithms, such as wherein learnings may be made from accumulated source report data, risk rating of other sources or competitors, increase in multi-sourcing to effect change in the risk score, and the like. Further and by way of non-limiting example, the learnings may cause modification to automated weightings assigned, or aspects thereof, to one or more of the attributes.

Of note, the attributes discussed herein are provided by way of non-limiting example only. That is, other attributes may be available to be applied in the risk model, such as the financial stability of a supplier, reseller, or manufacturer. The attributes applied as impacting the risk model may, of course, be gleaned from particular data sets relevant to particular industries, products, or product types, by way of non-limiting example.

Accordingly, an unlimited number of parts within a given product, and a virtually unlimited number of nodes within a supply chain, may be individually reviewed for risk, and may be subjected to particular recommendations that would improve the risk profile. The user may be provided with all such recommendations, or only those recommendations which the user wishes or is authorized to see. Simply put, the risk analysis in the embodiments may be based upon both a current-state analysis (i.e., a weather or political incident, or a current lack of parts), as well as a predictive analysis that projects future part availability, etc. Predictive life cycle curves result from applying a predictive model that projects decline over time, either due to end of life, end of availability, or end of competitiveness, for each part, such as starting today and extending out into the future.

The end of life aspect may comprise a combination of global, anonymized data across all uses of that part and similar parts across all supply chains for which data is available, and of third party data sources available via accessible network links, and is configured to identify significant inflection points in a part's life cycle based on correlations to key features in the data that can be used to predict when a part can be expected to decline. Since the disclosed models and system rely on multiple data sources and a broad cross-section of global anonymized data (at primary node/hub 101), they benefit from a far more comprehensive information base than what is currently available, at least in that the learnings from the global data across many supply chains (each of which is likely proprietary, and would thus not be available in the known art for analysis) can both challenge or be augmented by complementary external data. The end of availability and end of competitiveness aspects of the model may be built solely upon the global data that is collected from across many proprietary supply chains, as well as direct from part manufacturers/sellers, and are algorithmically incorporated into the predictive curves. For example, if a manufacturer starts to progressively limit availability of a part, it is a likely indication that fewer of those parts are being made—meaning the end of availability timeframe is nearing proportionally to the increase in the limitation on the available parts.

Aspects of the predictive model employed herein leverage a survival analysis methodology that predicts time until an event. This methodology is commonly applied in actuarial sciences in determining insurance policy premiums, or in modeling recurrence in clinical treatment trials. For example, in buying a life insurance policy, the insurance company will use models to predict the likelihood of death during each policy period, starting today out through the maximum policy lifetime. To determine how likely that is to happen, and consequently how much to charge for the policy, the insurance company might ask for demographic information, lifestyle indicators, family history or even ask for a physical with a doctor. The actuarial model will then take in all of that information to draw out a curve that represents the likelihood of death over time. For example, a 25 year old runner who doesn't smoke and has no negative family medical history is less likely to die this year than a 75 year old smoker who is overweight and has high blood pressure. The result from that model will thus reflect this risk as a percentage over time, and will increase the further out time goes because of increasing age, prospective changing health indicators, or both. For example, the model might predict that if one smokes at age 75, one is unlikely to quit smoking before death, so it's a continued increasing risk factor into the future, whereas just because one runs at age 25, the odds of still being a runner at 35, let alone at 75, steadily decrease, thus increasing health risk.

How a model determines which factors to weight more heavily than others in the risk of death projection, and by how much, is generally the unique intellectual property of each company. In general though, the model is developed by allowing it to learn from historical data where there are instances of death of a great many individuals who have been tracked over time, which provides a mapping out of which factors are highly correlated to death. By determining which factors are associated with higher/lower/different death rates, the model can use those relationships to predict future rates for individuals with a similar profiles based on those attributes.

That current algorithm uses the same approach to model part “death”, as discussed herein above. More particularly, the attributes analyzed may include part attributes, uses (and health of the vertical(s) in which use occurs), typical decline rates of similar parts in general and within a vertical, known declines in availability or delivery rates, and market information, by way of non-limiting example. The model may include vast amounts of historical data over many years, such as by being present at the primary node/hub 101 through which a large number of supply chains are run, as discussed throughout. Part attributes that may be considered and may influence the shape of the risk curve include all data around years to end of life, life cycle code and part change notification dates, supply, price and market dynamics, flagged last-time buy or decreased availability/purchase-limit indicators and manufacturer, and commodity specific adjustments.

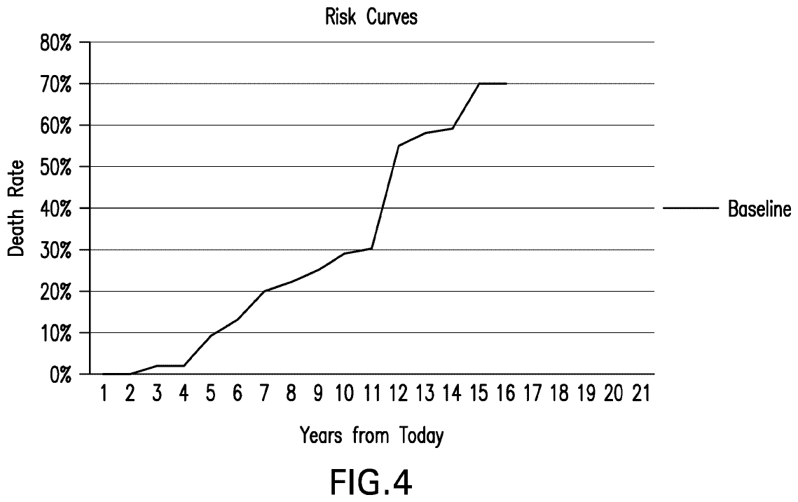

The model iteratively tests and either includes or excludes factors based on statistical significance. To test against, a baseline survival curve may be drawn based on the overall part death by time period over the training data set from a selected date of introduction through end of a time period, as indicated by the voluminous data at hub-primary node 101. This is illustrated in FIG. 4.

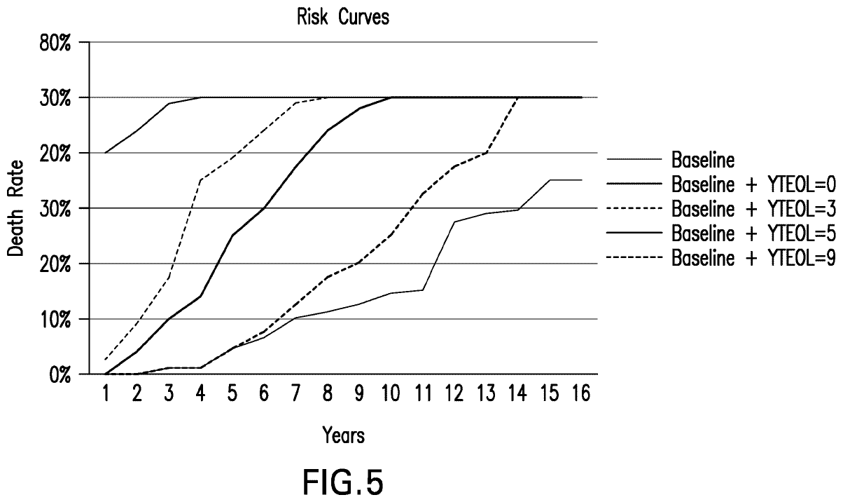

This can be interpreted to show the average percentage of parts that will “die” at a different time increments into the future. For example, at year 8, 22% of parts will have died and 78% of parts will live longer. The model then selects the next most important factor that is significantly related to the death rate; in other words, as to how this curve differs for subsets of the data, i.e., for specific parts or parts having specific characteristics, which subsets are the most significantly different, and is this factor one such “very different” curve? The model then adds in the “very different” factors and adjusts the equation and consequently curves that are drawn based on the value of that factor, as shown in FIG. 5A.

In the example of FIG. 5A, a part with an estimated YTEOL of 0 is actually predicted to die within 4 years, whereas a part with an estimated YTEOL of 9 is actually predicted to die with 14 years. Note that the present model improves upon the third party data estimate (i.e., 0 and 9 years to end of life) by leveraging the very broad historical data across many supply chains and across many parts of similar usage and profile available at the hub 101, and may also relate to the fact that the data from the hub 101 may illustrate an awareness of substitute parts and/or alternative manufacturers/suppliers, which may also lead to an extended end-of-life profile.

As more attributes are added for a given part, more alternative curves are drawn out by the model and projected to account for each different combination of potential “different” or “very different” factors. The curve selected may be the one given the highest probability of being actualized, based on the existing historical data at hub 101. When a new part is run through the model to generate a prediction, the new part may receive an estimate curve based on other parts that have the same or a similar combination of values for attributes in the model, by way of example. Of note and as indicated in the exemplary graphs provided, not all parts may face a projected eventual death in the presently applied algorithms. That is, some parts (such as transistors and other consistently useable parts) will not ever approach 100% risk in the present modelling.

As referenced, the model also includes an end of competitiveness decrement factor, which accounts for additional risk from older, yet potentially still available, components. For example, a component that makes a product wireless-3G enabled might still be in production and might be available for sourcing, notwithstanding that the cellular market has moved toward 5G, and so the part is no longer competitive and will inherit additional risk. The competitiveness life cycles and curves leverage this insight and knowledge from the central hub's broad data base. Further, this on-competitive risk of a part may vary by industry. For example, a connected healthcare device doesn't need to stay up to date on wireless technology, but a mobile phone device does. Thus, an out-of-competitiveness 3G wireless component for a cell phone carries a much higher risk than when used on a medical device.

Each component risk score may also be combined into a product-level design aggregate risk. This aggregate score may account for overlapping versus independent risk, and mitigation efforts to remedy risk. For example, in the aggregate, having no alternatives for particular components contributes more significantly to an aggregate product risk than if various parts do have alternatives.

The product-level aggregated risk at each point in time may be calculated as:

Revenue with Impact=Revenue−(Revenue*Risk).

The risk is detailed above, and is dependent on individual parts, the risk of each part, and the available alternatives to higher risk parts. The revenue with impact necessarily declines over time.

FIG. 5B shows a GUI 3100 providing the calculated potential impact dollars 3102, which represents the potential lost revenue, per the calculation above, resulting from risky parts impacting either supply or market demand of the final product over the time period specified, compared with the cost to mitigate (upper, smaller bar for each part) 3104. This will support prioritizing what product(s) need the most focus on de-risking, and when.

The graphical user interface (GUI) 3200 of FIG. 5C provides a view of all parts 3202 on the BOM that are driving risk, and the potential impact to assurance of supply/market competitiveness. The height of the stacked bar corresponds to the product risk 3204, and the components/parts that contribute to the overall product risk are displayed proportionally 3206 within the stack based on the weight each part contributes to the overall risk.

Simply put, product level risk aggregation is based by the risk module 311 on a predictive survival analysis of the individual parts on the BOM to determine, at each point in the future, the expected rate of decline in the part life. The risk represents the likelihood of, and amount of impact of, a disruption of supply, either due to end of life parts or market conditions, or end of competitiveness leading to decreased demand, as detailed throughout.

For example, if a product is using a larger case size capacitor that is going end of life, as that component approaches its EOL, the decreased market availability will introduce risk of a shortage, which consequently impacts both the central hub and the customer's revenue. The information of FIG. 5 may thus be viewed from both a central hub perspective or from a customer perspective. Products or parts can be sorted by, for example, potential revenue impact, potential revenue impact, or time or cost to redesign, such as via drop down selection.

The aggregate-level product analysis comprises the herein-discussed series of algorithms applying the disclosed calculations within the risk module 311. More specifically, the calculations disclosed may encompass, as attributes included in the aggregate analysis, the start date, which may be the date a product or component first has a data set available; death date, which is an end of life date for a product or component, and which may require a certain amount of data to estimate; trigger events, which provide data inflection/change points for components or products; available alternatives; and lead time changes and supply limit changes, by way of non-limiting example.

The trained algorithmic models 311 may, among other aspects, apply the following specific algorithm:

h(t)=h0(t)*exp(b1×1+b2×2+ . . . +bp×p)

wherein:
t represents the survival time;
h(t) is the hazard function determined by a set of p covariates (x1, x2, . . . , xp);
(b1, b2, . . . , bp) are the coefficients and measure the impact (i.e., the effect size) of covariates; and
h0 is the baseline hazard and corresponds to the value of the hazard if all the xi are equal to zero.
A shift is then calculated to reshape the curve leading up to critical dates/triggers.

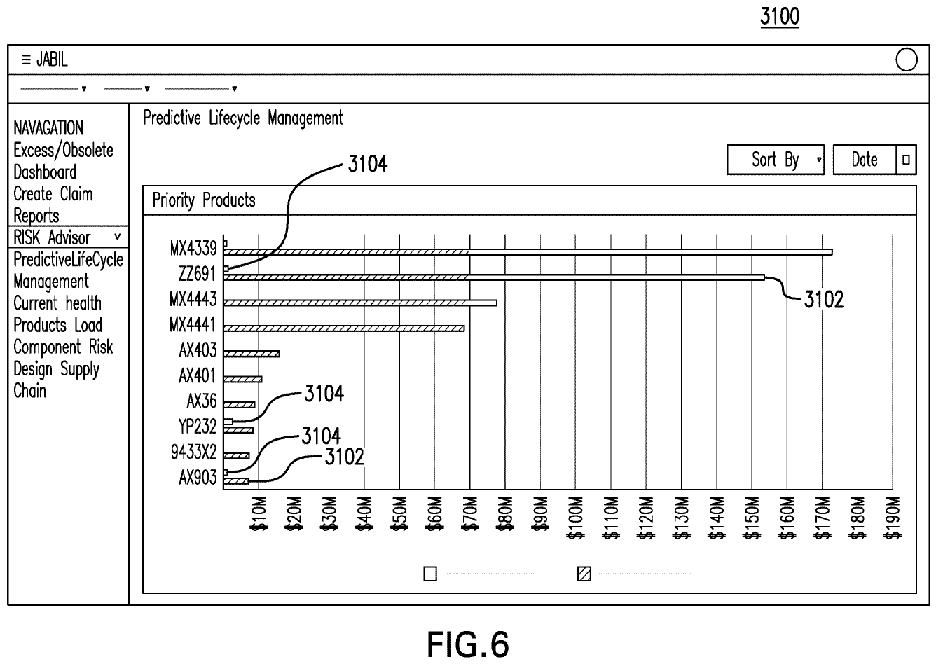

More particularly, the foregoing analysis may reside in the risk advisor/analysis module 311 that may include two sub-modules: a predictive life cycle management module 311a, and a current health assessment module 311b. This is illustrated in FIG. 6.

The predictive life cycle management module 311a is a proactive strategic risk assessment, as discussed throughout. The issue with current risk assessment approaches is they are dependent upon current risk analysis—meaning, by the time a risk is assessed as currently present, a supply chain problem already exists. Thus, the disclosed embodiments' solution focuses on projections based upon key time variable factors, like an EOL calculator 3302 that includes End of Life, Allocation, Market Conditions, Competitive End of Life and Technology Cycles to create a predictive risk assessment that may include an assessment of the potential impact of the risk 3304. These time-centric factors allow for recommendations 3306 for a re-design 3308, such as regarding alternative parts 3310 or technological modifications 3312 related to the use of individual parts, or for an overall output product, in anticipation of a supply chain issue, rather than responsive to an existing issue.

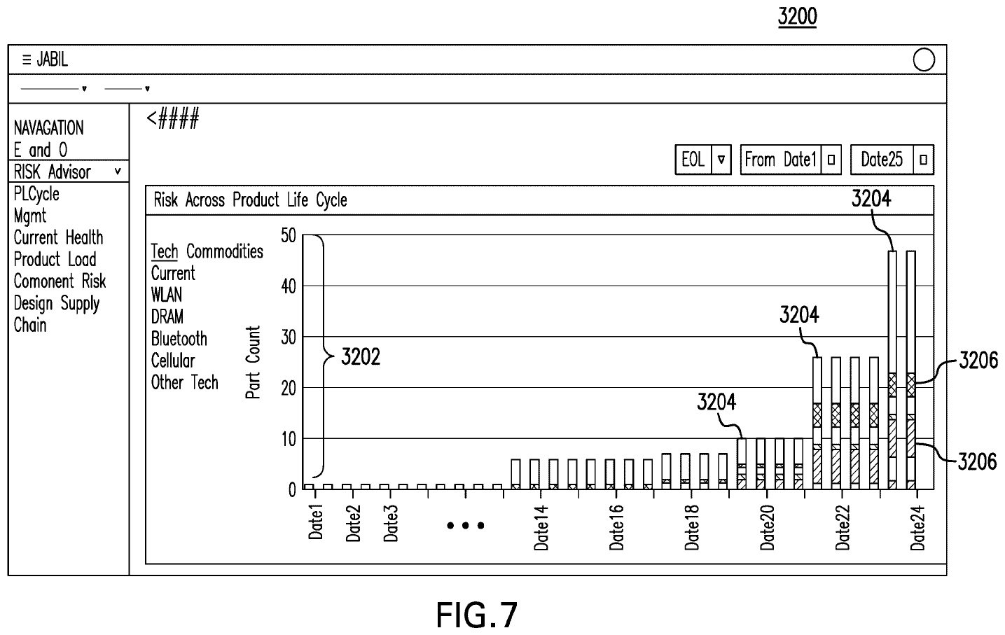

Further, such a re-design may occur automatically, or may be recommended to a user, based on a predetermined threshold or series of triggers responsive to the projection factors discussed herein, and may be illustrated to the user via a simulation 3320. For example and as illustrated in FIG. 7 (GUI 3400), a list of products (or parts within a product) may be associated with a prospective de-risking value, which may additionally include the cost of a redesign (in a system wherein the disclosed embodiments reside at a central hub, integrated with supply chains at several different on-sites). That is, upon entering the risk management module, a user may access certain products, bills of materials for products, and individual parts on the bills of materials.

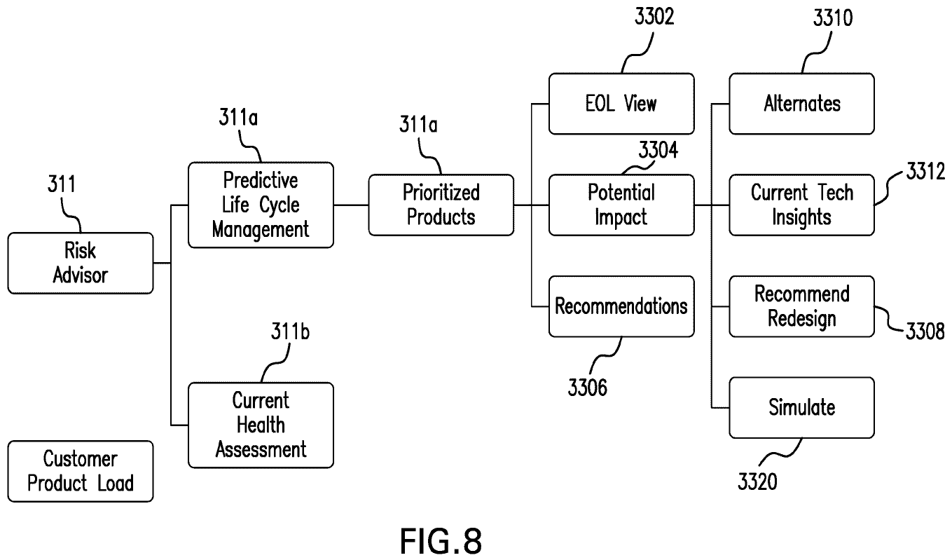

FIG. 8 illustrates with particularity an informational graph associated with a certain product. The ideal product life cycle of revenue for this type of product in the subject vertical is shown by the upper line in the graph. However, the actual realized revenue will instead, per the projections of the model, follow the lower line in the graph, absent a redesign.

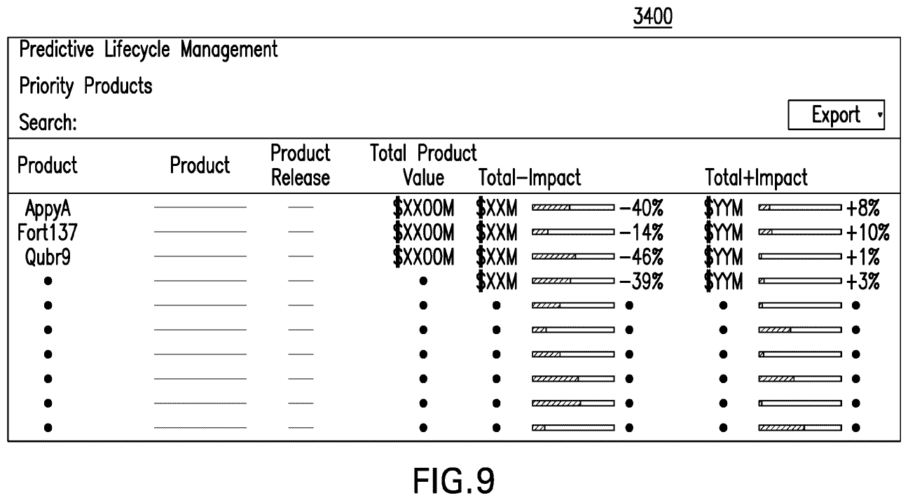

FIG. 9 shows a GUI 3500 relaying the reasoning of the predictive model for the substandard performance of the revenues in FIG. 8. More specifically, the popout 3502 of FIG. 9 shows the outcome of the predictive model discussed herein—namely that various parts 3504 within the subject product are nearing their respective (end of life) EoL, and several parts are already in an EoL phase-out.

As discussed throughout, a part/product in the EoL phase is within a certain timeframe of its prospective end-of-availability, and a part in phase-out may already be out of production, or close to out of production, even if some suppliers still have the part on-hand. By way of example, given the movement of cellular communications towards 5G, parts from several generations earlier of prior wireless communications chipsets, such as 3G chip sets, may soon reach EoL/obsolescence/out-of-production.

Needless to say, the continued use of these EoL or near-EoL parts in the product carries with each respective use a risk to the revenue of the product, as shown. Of course, a redesign can de-risk these parts, and hence de-risk the overall product, which will improve the adherence of revenue in the “actual” curve of Figure E to the ideal curve. Thus, the disclosed embodiments improve revenue vi a predictive de-risking before a supply chain issue has occurred.

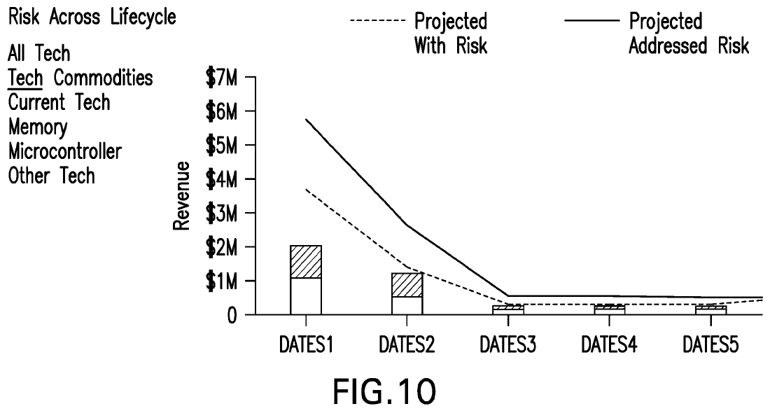

FIG. 10 is a de-risk simulation outcome graph, for revenue, related to the prospective redesign related to the problematic parts found by the model in FIG. 9. Of note, the actual revenue curve (the lower curve in FIG. 10) now much more closely approximates the ideal revenue curve (the upper curve in FIG. 10) as compared to the curves of FIG. 8.

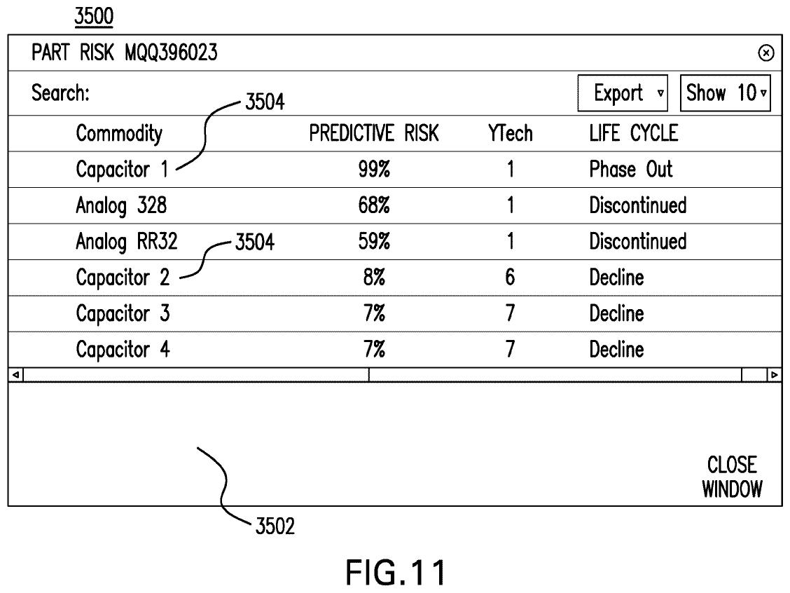

FIG. 11 illustrates a GUI 3600, for an exemplary product, of an executed redesign projection that leads to a graph such as that of FIG. 10. More specifically, the redesign illustrates a list of parts 3602 that have been redesigned for product 3603, and the respective effects 3604 of implementing changes to each of those parts on the overall approximation of the ideal revenue in FIG. 10. As such, a customer may select “a-la-carte” which changes to implement to the product, thereby minimizing the implementation cost of the redesign while maximizing the impact of the redesign on actual revenue over time. Moreover, the presence (or analysis) of parts may be excluded from the predictive risk analysis based on any desired threshold—such as, for example, no parts with less than a 5% impact on revenue over a 3 year threshold—to thereby save on the costs of the redesign as well as its implementation.

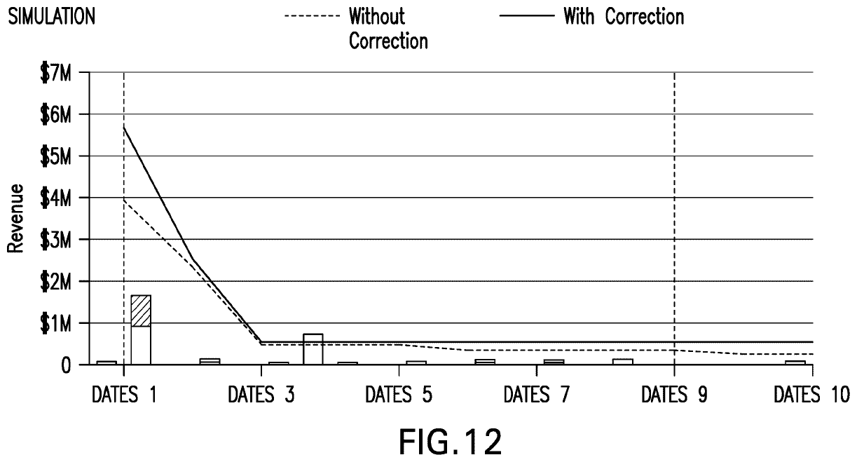

Of course, further available, such as via drill down, in this a-la-carte de-risk analysis may be the specific alternative parts, and their respective associated risk, involved in the redesign. Also available, such as based on the user-roles discussed herein, may be an advantage of a redesign to additional clients of the central hub, by way of non-limiting example. The skilled artisan will appreciate that other optionality, such as trigger thresholds; time frames for redesign, such as may include timeframes in which funds would be available (or threshold funds) for a redesign; selection of particular products or sub-products that may be subjected to the redesign; focus parts for a redesign; etc., may also be available for modification in the current modelling. This is illustrated, by way of example, in the GUI 3700 of FIG. 12.

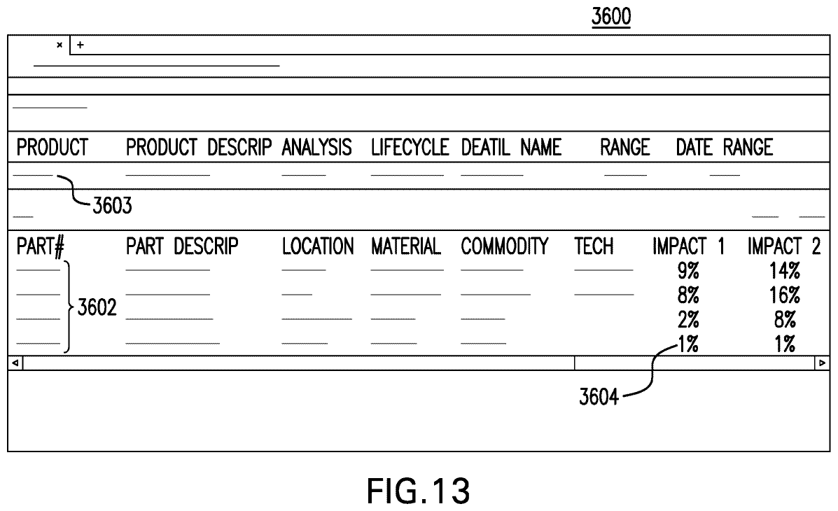

FIG. 13 illustrates a GUI 3800 for an additional component available from the risk module 311, namely a “health assessment” module 311b. Included in this feature may be various knowledge known principally to the central hub, based on its large volume of available anonymized data, but perhaps not to the customer. Included information may be component sourcing optionality, such as multi-source versus single source part options; EoL projections by part; and preferred supplier or manufacturer pricing. This information may be available via customer pricing, central hub pricing, and so on. Simply put, the EoL of a given part may have substantially more revenue impact on a customer's product than it does across all products produced by all of the supply chains of the central hub. That is, the risk to a customer on a single product from an obsolescence may be substantially higher than the risk to a supplier of many customers across many products.

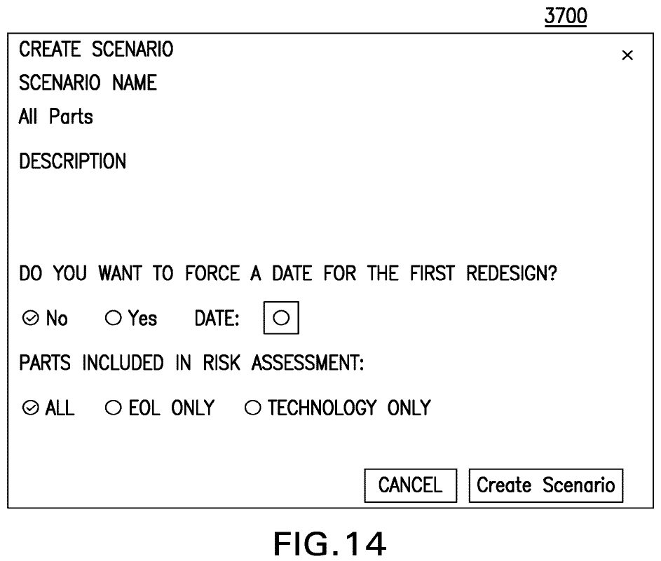

In the GUI 3900 of FIG. 14, a temperature sensor on a product may be determined to likely be out of date by Q2 2020, and thus alternate parts may be needed before that time to avoid obsolescence. It may be known that this sensor has a 48 month cycle, so it will become further obsolete upon major design revisions at Q2 2024 and again at Q2 2028. The cost of a redesign may progressively increase through Q2 of 2028, and consequently the customer may wish to find alternate parts, as shown, and/or redesign at either for Q2 of 2020 or, if funds are unavailable at that time, prior to or during the design revision of Q2 2024.

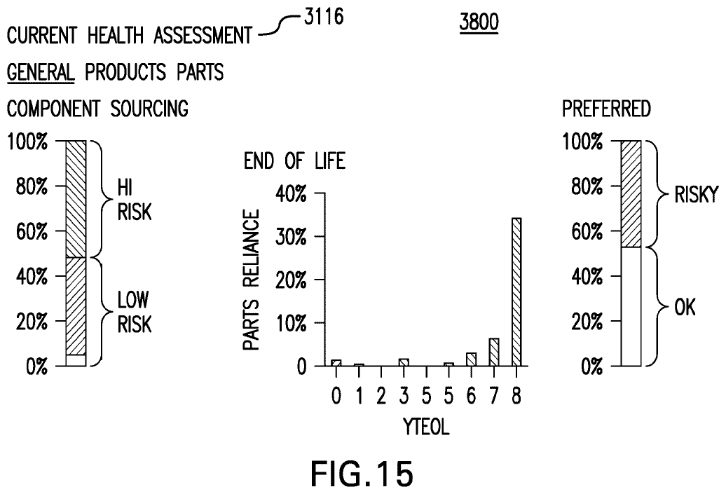

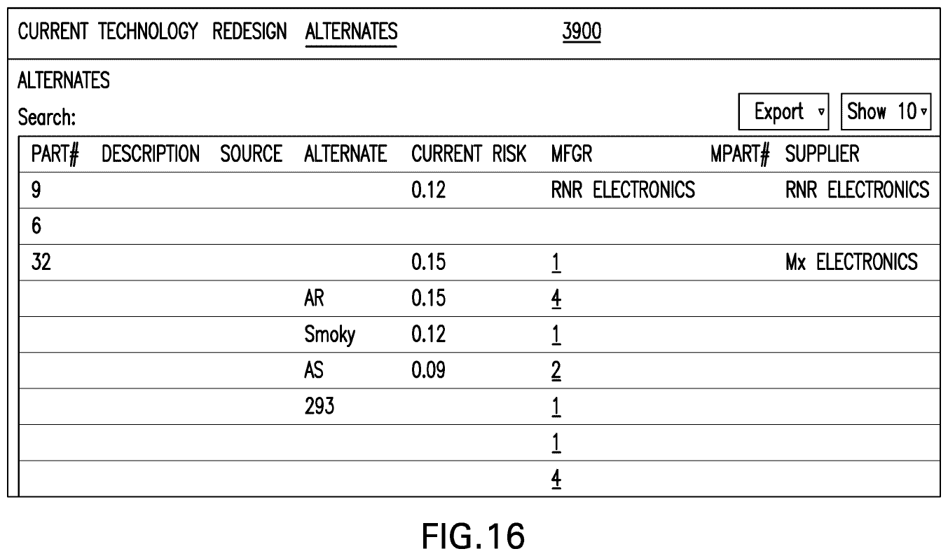

The foregoing predictive risk analysis may also be simulated, both for the prospective effects on a supply chain of a recommended redesign, as referenced above, and additionally for a user-input redesign. As illustrated in FIGS. 15 and 16, selection of the former simulation, i.e., a simulation to illustrate the prospective effects of a recommended redesign to address risk factors via GUI 4000, may provide a before and after simulation of the redesign in GUI 4200. Results may be provided as a side-by-side comparison of risk before (i.e., if nothing is done) compared to after (i.e., if the recommended redesign(s) are implemented), as illustrated particularly in FIG. 16.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A supply chain predictive risk manager for managing a supply chain comprising a plurality of supply chain nodes, comprising:
a managing central hub comprising a plurality of primary data regarding anonymized hardware and software product data from the plurality of supply chain nodes, and life cycle data for all parts employed at the plurality of supply chain nodes;
an input to the managing central hub comprising current proprietary data regarding a product made at one of the plurality of supply chain nodes;
a plurality of rules stored in at least one memory element associated with the managing central hub and capable, based on the primary data, of recognizing a predictive non-competitive part related risk embedded in the proprietary data, the plurality of rules calculating, based on accumulated part related risk data from at least providers of parts and from the primary data, a recommended redesign to address the predictive non-competitive part related risk before it arises; and
an output from the managing central hub to a graphical user interface, wherein the non-competitive part related risk and the recommended redesign are presented by a processor on the graphical user interface.

2. The risk manager of claim 1, wherein the predictive non-competitive part related risk comprises an end of life for the parts.

3. The risk manager of claim 1, wherein the predictive non-competitive part related risk comprises a lack of availability for the parts.

4. The risk manager of claim 1, wherein the predictive non-competitive risk varies in accordance with a competitive arena of the one of the plurality of supply chain nodes.

5. The risk manager of claim 1, wherein the predictive non-competitive risk varies in accordance with a geographic area of the one of the plurality of supply chain nodes.

6. The risk manager of claim 1, wherein the predictive non-competitive risk varies in accordance with a geographic source point of the parts.

7. The risk manager of claim 1, wherein the recommended redesign comprises alternate sources of ones of the parts.

8. The risk manager of claim 1, wherein the recommended redesign comprises alternative ones of the parts.

9. The risk manager of claim 1, wherein the life cycle data is historic.

10. The risk manager of claim 1, wherein the life cycle data is predictive.

11. The risk manager of claim 10, wherein the prediction is based on similar parts.
